(19) United States
(12) Patent Application Publication
(10) Pub. No.: US 2015/0039607 A1
(43) Pub. Date: Feb. 5, 2015

(54) PROVIDING A SUMMARY PRESENTATION

(71) Applicant: Google Inc., Mountain View, CA (US)

(72) Inventor: Ryan James Lothian, Harpenden (GB)

(21) Appl. No.: 13/955,327

(22) Filed: Jul. 31, 2013

(51) Int. Cl. G06F 17/30

(52) U.S. Cl. CPC G06F 17/3053
USPC 707/732; 707/722; 707/723

(57) ABSTRACT

Implementations generally relate to providing a summary presentation. In some implementations, a method includes determining a triggering event associated with a subject person. The method also includes receiving a plurality of media content items associated with the subject person. The method also includes selecting media content items from the plurality of media content items based on one or more predetermined selection criteria. The method also includes providing a summary presentation of the selected content media items.

### BACKGROUND

Social network systems often enable users to upload media content such as photos and enables users to create photo albums. Social network systems also enable users to share photos with each other. For example, users can share photos with friends and family, which provides bonding experiences among users of a social network system. A user can create a photo album that is associated with the user's profile. As owner of the photo album, the user can then allow other users to view the photo album when visiting the photo section of the user's profile.

### SUMMARY

Implementations generally relate to providing a summary presentation. In some implementations, a method includes determining a triggering event associated with a subject person. The method also includes receiving a plurality of media content items associated with the subject person. The method also includes selecting media content items from the plurality of media content items based on one or more predetermined selection criteria. The method also includes providing a summary presentation of the selected content media items.

With further regard to the method, in some implementations, the triggering event includes the subject person passing away. In some implementations, the receiving includes searching for the media content items in response to detecting the triggering event. In some implementations, the plurality of media content items includes one or more of videos, images, and audio recordings. In some implementations, the predetermined selection criteria include whether a media content item includes the subject person. In some implementations, the predetermined selection criteria include whether a media content item includes content that meets one or more social affinity criteria. In some implementations, the predetermined selection criteria include whether a media content item includes content that meets one or more importance criteria. In some implementations, the predetermined selection criteria include whether a media content item includes content that meets one or more quality criteria. In some implementations, the predetermined selection criteria include whether a set of media content items includes content that meets one or more diversity criteria. In some implementations, the selecting of the media content items includes ranking based on predetermined selection criteria, and selecting a predetermined number of media content items based on the ranking. In some implementations, the providing of the summary presentation includes selecting one or more recipients based on one or more recipient criteria.

In some implementations, a method includes determining a triggering event associated with a subject person. The method also includes receiving a plurality of media content items associated with the subject person, where the receiving includes searching for the media content items in response to the detecting of the triggering event, and where the media content items include one or more of videos, images, and audio recordings. The method also includes selecting media content items from the plurality of media content items based on one or more predetermined selection criteria, where the predetermined selection criteria include whether a media content item includes an image of the subject person, and where the predetermined selection criteria include whether a media content item includes content that meets one or more social affinity criteria. The method also includes providing a summary presentation of the selected content media items.

With further regard to the method, in some implementations, the triggering event includes the subject person passing away. In some implementations, the predetermined selection criteria include whether a media content item includes content that meets one or more importance criteria. In some implementations, the predetermined selection criteria include whether a media content item includes content that meets one or more quality criteria. In some implementations, the predetermined selection criteria include whether a set of media content items includes content that meets one or more diversity criteria.

In some implementations, a system includes one or more processors, and logic encoded in one or more tangible media for execution by the one or more processors. When executed, the logic is operable to perform operations including: determining a triggering event associated with a subject person; receiving a plurality of media content items associated with the subject person; selecting media content items from the plurality of media content items based on one or more predetermined selection criteria; and providing a summary presentation of the selected content media items.

With further regard to the system, in some implementations, the triggering event includes the subject person passing away. In some implementations, the receiving includes searching for the media content items in response to detecting the triggering event. In some implementations, the plurality of media content items includes one or more of videos, images, and audio recordings.

### BRIEF DESCRIPTION OF THE DRAWINGS

FIG. 1 illustrates a block diagram of an example network environment, which may be used to implement the implementations described herein.

FIG. 2 illustrates an example simplified flow diagram for providing a summary presentation, according to some implementations.

FIG. 3 illustrates an example simplified diagram of a network environment, according to some implementations.

FIG. 4 illustrates an example simplified diagram of a network environment, according to some implementations.

FIG. 5 illustrates a block diagram of an example server device, which may be used to implement the implementations described herein.

### DETAILED DESCRIPTION

Implementations for providing a summary presentation are described. In various implementations, a system determines a triggering event associated with a subject person. For example, in some implementations, the triggering event may include the subject person passing away. The system then receives media content items associated with the subject person. In some implementations, the system searches for the media content items in response to detecting the triggering event. In some implementations, the media content items may include videos, images, and audio recordings.

In various implementations, the system selects some of the media content items from the received media content items based on one or more predetermined selection criteria. For example, in some implementations, the predetermined selection criteria include whether a media content item includes the subject person. In some implementations, the predetermined selection criteria include whether a media content item includes content that meets one or more social affinity criteria. In some implementations, the predetermined selection criteria include whether a media content item includes content that meets one or more importance criteria. In some implementations, the predetermined selection criteria include whether a media content item includes content that meets one or more quality criteria. In some implementations, the predetermined selection criteria include whether a set of media content items includes content that meets one or more diversity criteria. The system then provides a summary presentation of the selected content media items. In some implementations, to provide the summary, the system may select one or more recipients based on one or more recipient criteria.

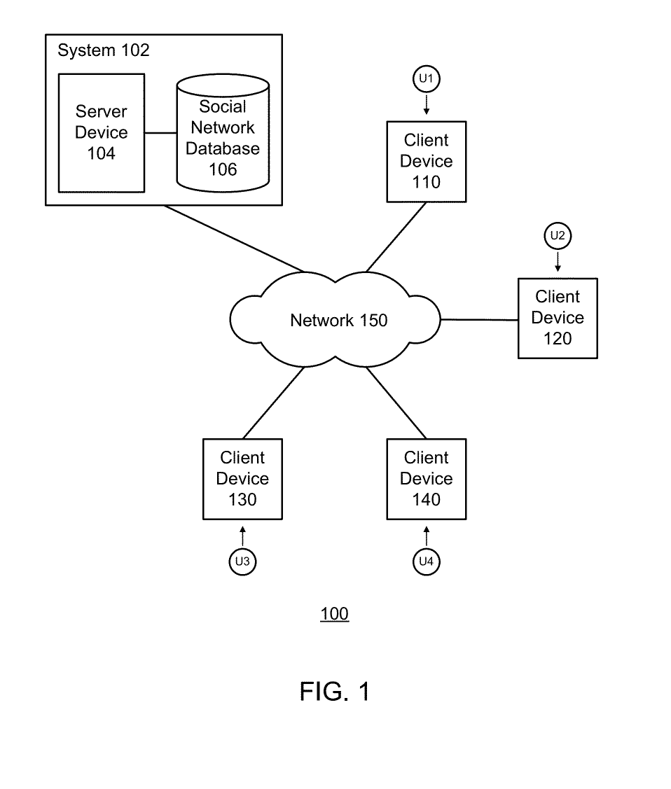

FIG. 1 illustrates a block diagram of an example network environment 100, which may be used to implement the implementations described herein. In some implementations, network environment 100 includes a system 102, which includes a server device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. In the various implementations, users U1, U2, U3, and U4 may upload and share various media content items (e.g., images, video, audio, etc.) to system 102 using respective client devices 110, 120, 130, and 140. In the various implementations described herein, processor 102 of system 102 may cause elements described herein (e.g., video, images, audio of a summary presentation, etc.) to be displayed in a user interface on a display screen of one or more client devices. In various implementations, system 102 may utilize a recognition algorithm to implement various implementations described herein. Example implementations of recognition algorithms are described in more detail below.

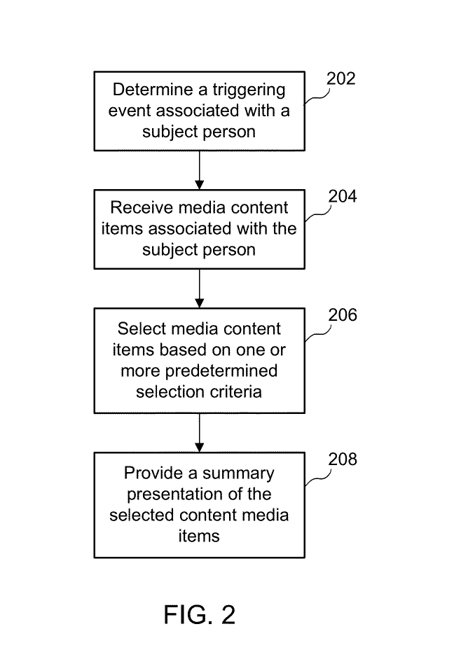

FIG. 2 illustrates an example simplified flow diagram for providing a summary presentation, according to some implementations. Referring to both FIGS. 1 and 2, a method is initiated in block 202, where system 102 determines a triggering event associated with a subject person. For example, in various implementations, the triggering event includes the subject person passing away. In some implementations, system 102 may determine a triggering event when system 102 receives an event indication (e.g., from a user). In some implementations, system 102 may enable a user to submit a particular event indication to system 102. For example, if the subject person passes away (dies), system 102 may enable a relative or friend to provide system 102 with an indication that indicates that the subject person has passed away. Such an indication may be in various forms. For example, system 102 may provide a selection of events to a user, and enable the user to make a selection (e.g., that another user has passed away). While some implementations are described in herein in the context of the subject person passing away, these implementations and others may apply to other contexts. For example, the selections may include a selection indicating that the subject person is terminally ill.

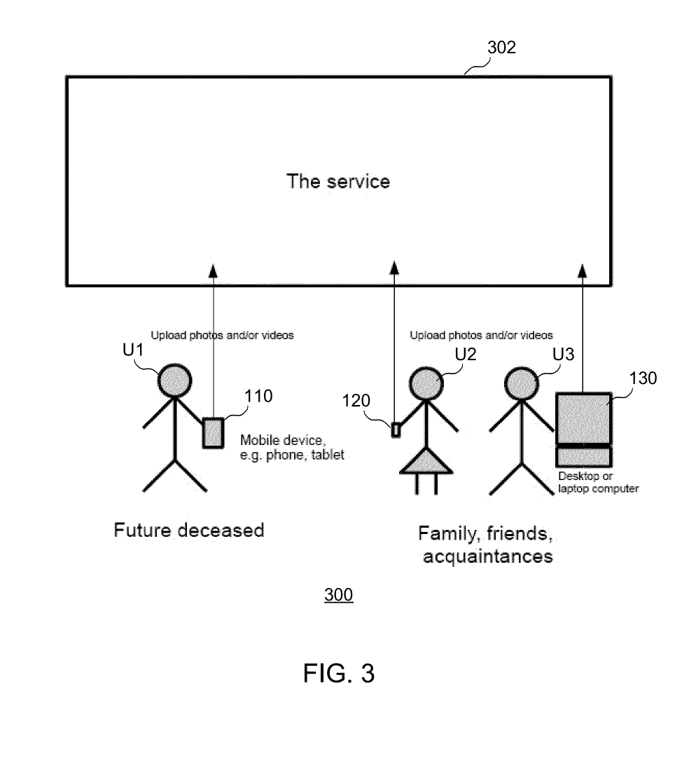

In block 204, system 102 receives media content items associated with the subject person. In various implementations, the receiving of the media content items may include system 102 searching for the media content items in response to detecting the triggering event. In various implementations, the media content items are not associated with the triggering event but are instead associated with the subject person. For example, the triggering event may be the subject person's passing away, but the media content items may be associated with the subject person, yet taken during previous events in the subject person's life (e.g., childhood photos, wedding photos, etc.). As described in more detail below in connection with FIG. 3, system 102 may provide a service that enables users to upload various media content items to system 102.

FIG. 3 illustrates an example simplified diagram of a network environment 300, according to some implementations. In various implementations, system 102 may provide a service 302 that enables users to upload various content media items to system 102. The media content items may include, for example, one or more videos, one or more photos and other images, and one or more audio recordings. FIG. 3 shows a scenario where a trigger event yet to occur is the subject person (e.g., user U1) passing away. As shown, before the trigger event, the subject person may use any suitable device (e.g., client device 110) to upload photos and/or videos to system 102 via service 302. Similarly, other users such as family, friends, acquaintances, etc. (e.g., users U2, U3, etc.) may use any suitable devices (e.g., client devices 120, 130, etc.) and also upload photos and/or videos to system 102 via service 302. System 102 stores the media content items in any suitable storage location.

In block 206, system 102 selects one or more of the media content items from the received media content items based on one or more predetermined selection criteria. In various implementations, the predetermined selection criteria include whether a media content item includes the subject person. Various other implementations directed to selecting media content items are described in more detail below. In various implementations, system 102 may use face recognition algorithms and/or voice recognition algorithms to find, recognize, and/or identify candidate media content items to include in the summary presentation. Various implementations of recognition algorithms are described in more detail below.

In block 208, system 102 provides a summary presentation of the selected content media items. In a scenario where the subject person has passed away, providing the summary presentation, the summary presentation gives the family, friends, and acquaintances of the subject person an opportunity to see photos and/or videos, and hear audio recordings associated with the deceased, highlighting that person's life.

In some implementations, the summary presentation may be presented to people at a particular event (e.g., a memorial service). In some implementations, the summary presentation may be shared with predetermined people (e.g., family, friends, and acquaintances) via a social network system or other means. In some implementations, the summary presentation may be posted on a website or web page associated with the subject person (e.g., the subject person's profile page), thereby forming a lasting memorial to the subject person's life.

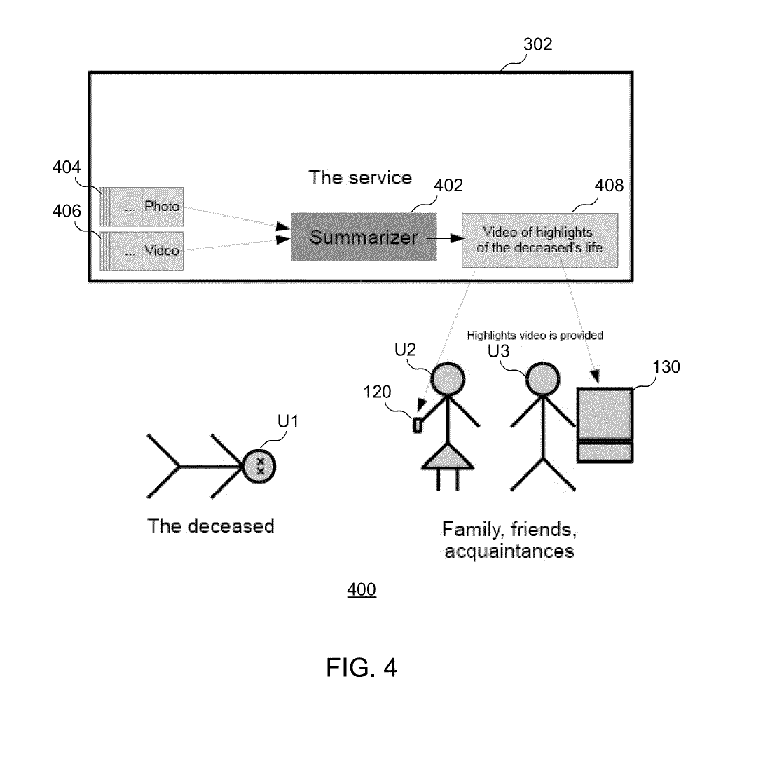

FIG. 4 illustrates an example simplified diagram of a network environment 400, according to some implementations. In various implementations, service 302 provided by system 102 includes a summarizer 402. In various implementations, summarizer 402 aggregates media content items such as photos 404, videos 406, etc. and any other media content items (e.g., audio recordings, etc.) into a summary presentation 408.

FIG. 4 shows a scenario where a trigger event has occurred, such as the subject person (e.g., user U1) having passed away. As shown, after the trigger event, system 102 may generate summary presentation 408 and provide summary presentation 408 to particular people such as family, friends, acquaintance, etc. (e.g., users U2, U3, etc.) via their respective devices (e.g., client devices 120, 130, etc.). In some implementations, system 102 may notify predetermined users of the triggering event. For example, system 102 may notify family and friends that the subject person has passed away, and may provide a summary presentation 408 to people via their respective devices.

In some implementations, system 102 may also enable a user to present summary presentation 408 to people at an in-person event such as at a memorial service, where summary presentation 408 is displayed on a large viewing screen (and/or displayed on individual devices).

In various implementations, the triggering event triggers the steps described herein. Note, however, that the media content items may include content from multiple events. For example, in the scenario where the subject person is deceased, the triggering event (e.g., the death of the subject person) triggers the steps described herein, which ultimately provides a summary presentation that contains a memorial of the subject person's life. As such, the summary presentation may include content associated with different times/events during the life of the subject person (e.g., graduations, marriage, trips, etc.).

In various scenarios, hundreds or even thousands of media content items may exist, all of which may be suitable content for a highlights video. In various implementations, system 102 automatically collects and aggregates selected media content items to create the summary presentation (e.g., highlights video). Such implementations save much time, costs, and human effort, which may otherwise be prohibitively costly.

In various implementations, system 102 may generate the summary presentation to present a predetermined length of material (e.g., 3 minutes of material, etc.), pairing down potentially many hours worth of available source material. As indicated herein, system 102 may select from various photos, videos, and audio source material to generate the summary presentation. As described in more detail herein, system 102 may apply a selection algorithm to select a set of suitable media content items for the summary presentation.

In various implementations, system 102 provides the summary by selecting one or more recipients based on one or more recipient criteria. To select the media content items, system 102 may apply a combination of various criteria to generate a total score for each media content item. For example, for each media content item, system 102 may generate a score for each different type of selection criteria. Various types of selection criteria are described in more detail below. System 102 may then generate the total score based on scores that reflect various types of selection criteria. System 102 may rank the media content items against each other based on their respective scores associated with the predetermined selection criteria. System 102 then selects a predetermined number of media content items based on the ranking. As a result, media content items with higher scores are more likely to be selected for the summary presentation. Various types of selection criteria are described in more detail below.

As indicated above, in some implementations, the predetermined selection criteria include whether a media content item includes the subject person. Such content may include, for example, images of the subject person, videos of the subject person, recordings of the subject person, etc. In various implementations, system 102 may utilize a recognition algorithm such as facial recognition and/or metadata (e.g., tags) to determine if a media content item includes the subject person.

In some implementations, the predetermined selection criteria include whether a media content item includes the subject person at a particular event. As indicated above, system 102 may utilize a recognition algorithm such as facial recognition and/or metadata (e.g., tags) to determine if a media content item includes the subject person. System 102 may also use any suitable recognition algorithm and/or metadata (e.g., tags) to determine if the content is associated with a particular event. Example implementations of recognition algorithms are described in more detail below. In various implementations, system 102 may give a higher score to media content items that include the subject person (e.g., photos of the subject person).

In some implementations, the predetermined selection criteria may include whether a media content item was taken by the subject person. In various implementations, after the subject person has taken photos, video, or audio with his or her device (e.g., camera device, video camera, smart phone, etc.), the device may upload the media content items to system 102 (automatically or manually). The media content items may be associated with subject person in a number of ways. For example, system 102 may associate a given media content item with the subject person using an identification number of the uploading device, which is associated with the subject person. System 102 may associate a given media content item with the subject person using the subject persons social network account. In various implementations, system 102 may give a higher score to media content items that the subject person took (e.g., photos associated with the subject person's family, hobby, etc.).

In various implementations, the predetermined selection criteria include whether a media content item includes content that meets one or more social affinity criteria. The social affinity criteria may include criteria associated with social distance between different people and the subject person. For example, system 102 may give a higher score to media content items that include people who are close to the subject person (e.g., family versus friends versus acquaintances, etc.). Each type of person may be given a different weight. For example, someone who is family may be given a higher score than someone who is an acquaintance.

In various implementations, the predetermined selection criteria include whether a media content item includes content that meets one or more importance criteria. For example, such importance criteria may include whether content is associated with passions and/or hobbies of the subject person. Such importance criteria may also include whether content was of interest to the subject person (e.g., favorite songs, music bands, etc.). System 102 may give a higher score to media content items that have content that appears to be more important to the subject person. In some implementations, system 102 may determine that particular content is more important to the subject person based on a variety of factors. In some implementations, quantity may be used as indication. For example, if the subject person has taken many pictures of a particular person (e.g., significant other), of particular content (e.g., a favorite pet), etc., media content items that include such content may be given a higher score.

In various implementations, the predetermined selection criteria include whether a media content item includes content that meets one or more quality criteria. In some implementations, quality criteria may include criteria associated with the overall image quality of a given content item (e.g., brightness, exposure, resolution, clearness, blurriness, colorfulness, etc.). As such, system 102 may give higher scores to higher quality images.

In some implementations, quality criteria may include criteria associated with the overall subject quality of a given media content item (e.g., whether the subject person is smiling, whether the subject person the central focus, etc.). In some implementations, quality criteria may include criteria associated with a particular event at which the summary presentation may be presented. For example, in the context of memorial service, quality criteria may be associated with particular colors, themes, songs, etc., that are appropriate for the memorial service. As such, system 102 may give higher scores to images with higher subject quality.

In various implementations, the predetermined selection criteria include whether a set of media content items includes content that meets one or more diversity criteria. In some implementations, diversity criteria may include a predetermined time distance between different media content items. For example, system 102 select content that spans the subject person's entire life, where some photos or video are taken from different ages. System 102 may give higher scores to media content items that best represent particular time periods (e.g., childhood, teens, 20s, 30s, 40s,), particular life milestones (e.g., graduations, marriage, etc.), etc.

In various implementations, system 102 may associate different media content items with different dates and/or time periods in a variety of ways. For example, system 102 may determine dates using timestamps of content media items. System 102 may ascertain dates using upload dates, share dates, etc. In some implementations, any given user may assign a date or time period to one or more content media items.

In various implementations, system 102 may associate different media content items with different life milestones in a variety of ways. For example, system 102 may determine if particular media content items were captured during particular events (e.g., graduations, wedding ceremonies, etc.) using metadata (e.g., tags) and/or pattern recognition algorithms. Example implementations of recognition algorithms are described in more detail below.

In various implementations, system may group sets of media content items into time periods based on associated dates and/or themes based on content (e.g., graduations, wedding ceremonies, etc.) and then select one or more representative media content items from each group. In various implementations, system 102 avoids redundancy (e.g., having too many media content items having the same content).

In some implementations, the predetermined selection criteria include whether particular guest are present at an event associated with the presentation of the summary presentation. For example, selection criteria may include whether guests attending an event to view the summary presentation are included a given media content item. As such, the summary presentation may have more impact on guests when they are shown with the subject person.

In some implementations, system 102 may enable users to manually tag particular media content items to indicate (or vote) as to which items are to be included in the summary presentation. In some implementations, system 102 may enable users to upload particular media content items to indicate (or vote) as to which items are to be included in the summary presentation. System 102 may receive such tag or uploaded media content items from applications local to user's client devices.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

In various implementations, system 102 may utilize a variety of recognition algorithms to recognize faces, landmarks, objects, etc. in images. Such recognition algorithms may be integral to system 102. System 102 may also access recognition algorithms provided by software that is external to system 102 and that system 102 accesses.

In various implementations, system 102 enables users of the social network system to specify and/or consent to the use of personal information, which may include system 102 using their faces in images or using their identity information in recognizing people identified in images. For example, system 102 may provide users with multiple selections directed to specifying and/or consenting to the use of personal information. For example, selections with regard to specifying and/or consenting may be associated with individual images, all images, individual photo albums, all photo albums, etc. The selections may be implemented in a variety of ways. For example, system 102 may cause buttons or check boxes to be displayed next to various selections. In some implementations, system 102 enables users of the social network to specify and/or consent to the use of using their images for facial recognition in general. Example implementations for recognizing faces and other objects are described in more detail below.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In various implementations, system 102 obtains reference images of users of the social network system, where each reference image includes an image of a face that is associated with a known user. The user is known, in that system 102 has the user's identity information such as the user's name and other profile information. In some implementations, a reference image may be, for example, a profile image that the user has uploaded. In some implementations, a reference image may be based on a composite of a group of reference images.

In some implementations, to recognize a face in an image, system 102 may compare the face (e.g., image of the face) and match the face to reference images of users of the social network system. Note that the term “face” and the phrase “image of the face” are used interchangeably. For ease of illustration, the recognition of one face is described in some of the example implementations described herein. These implementations may also apply to each face of multiple faces to be recognized.

In some implementations, system 102 may search reference images in order to identify any one or more reference images that are similar to the face in the image. In some implementations, for a given reference image, system 102 may extract features from the image of the face in an image for analysis, and then compare those features to those of one or more reference images. For example, system 102 may analyze the relative position, size, and/or shape of facial features such as eyes, nose, cheekbones, mouth, jaw, etc. In some implementations, system 102 may use data gathered from the analysis to match the face in the image to one more reference images with matching or similar features. In some implementations, system 102 may normalize multiple reference images, and compress face data from those images into a composite representation having information (e.g., facial feature data), and then compare the face in the image to the composite representation for facial recognition.

In some scenarios, the face in the image may be similar to multiple reference images associated with the same user. As such, there would be a high probability that the person associated with the face in the image is the same person associated with the reference images.

In some scenarios, the face in the image may be similar to multiple reference images associated with different users. As such, there would be a moderately high yet decreased probability that the person in the image matches any given person associated with the reference images. To handle such a situation, system 102 may use various types of facial recognition algorithms to narrow the possibilities, ideally down to one best candidate.

For example, in some implementations, to facilitate in facial recognition, system 102 may use geometric facial recognition algorithms, which are based on feature discrimination. System 102 may also use photometric algorithms, which are based on a statistical approach that distills a facial feature into values for comparison. A combination of the geometric and photometric approaches could also be used when comparing the face in the image to one or more references.

Other facial recognition algorithms may be used. For example, system 102 may use facial recognition algorithms that use one or more of principal component analysis, linear discriminate analysis, elastic bunch graph matching, hidden Markov models, and dynamic link matching. It will be appreciated that system 102 may use other known or later developed facial recognition algorithms, techniques, and/or systems.

In some implementations, system 102 may generate an output indicating a likelihood (or probability) that the face in the image matches a given reference image. In some implementations, the output may be represented as a metric (or numerical value) such as a percentage associated with the confidence that the face in the image matches a given reference image. For example, a value of 1.0 may represent 100% confidence of a match. This could occur, for example, when compared images are identical or nearly identical. The value could be lower, for example 0.5 when there is a 50% chance of a match. Other types of outputs are possible. For example, in some implementations, the output may be a confidence score for matching.

For ease of illustration, some example implementations described above have been described in the context of a facial recognition algorithm. Other similar recognition algorithms and/or visual search systems may be used to recognize objects such as landmarks, logos, entities, events, etc. in order to implement implementations described herein.

Implementations described herein provide various benefits. For example, in a scenario where the subject person has passed away, implementations described herein provide a summary presentation of photos, videos, and/or audio recordings, which gives the family, friends, and acquaintances of the subject person an opportunity to see/hear highlights of that person's life. Implementations may reuse data that has already been stored by the system. As such, there is little or no need to collect photos/videos from friends/family/acquaintances when the subject person passes away. The summary presentations is produced very quickly (within seconds or minutes) once the system receives notification of the trigger event (e.g., the subject person's death).

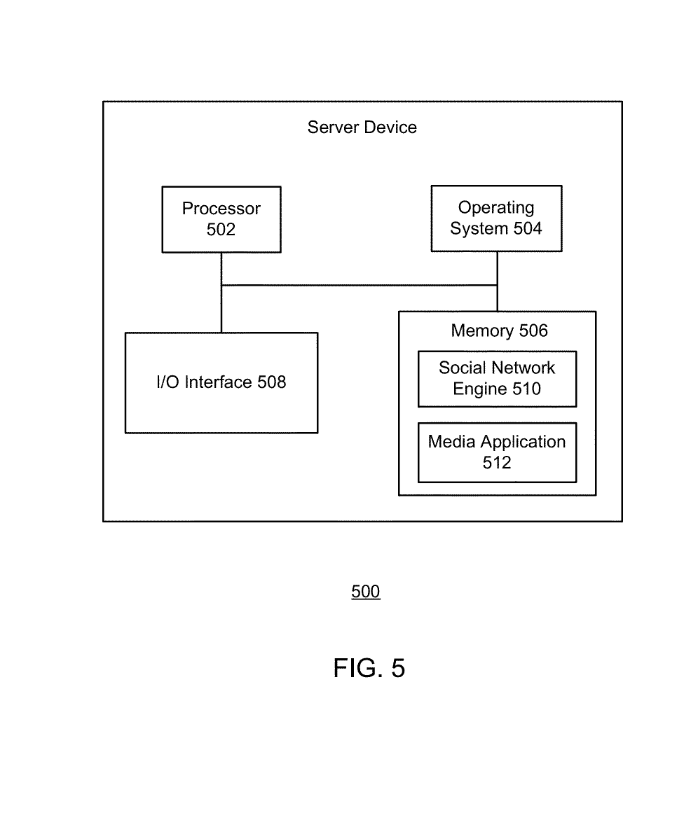

FIG. 5 illustrates a block diagram of an example server device 500, which may be used to implement the implementations described herein. For example, server device 500 may be used to implement server device 104 of FIG. 1, as well as to perform the method implementations described herein. In some implementations, server device 500 includes a processor 502, an operating system 504, a memory 506, and an input/output (I/O) interface 508. Server device 500 also includes a social network engine 510 and a media application 512, which may be stored in memory 506 or on any other suitable storage location or computer-readable medium. Media application 512 provides instructions that enable processor 502 to perform the functions described herein and other functions.

For ease of illustration, FIG. 5 shows one block for each of processor 502, operating system 504, memory 506, I/O interface 508, social network engine 510, and media application 512. These blocks 502, 504, 506, 508, 510, and 512 may represent multiple processors, operating systems, memories, I/O interfaces, social network engines, and media applications. In other implementations, server device 500 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a social network system. However, the implementations described herein may apply in contexts other than a social network. For example, implementations may apply locally for an individual user.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

What is claimed is:

1. A method comprising:
determining a triggering event associated with a subject person;
receiving a plurality of media content items associated with the subject person, wherein the receiving includes searching for the media content items in response to the detecting of the triggering event, and wherein the media content items include one or more of videos, images, and audio recordings;
selecting media content items from the plurality of media content items based on one or more predetermined selection criteria, wherein the predetermined selection criteria include whether a media content item includes an image of the subject person, and wherein the predetermined selection criteria include whether a media content item includes content that meets one or more social affinity criteria; and
providing a summary presentation of the selected content media items.

2. The method of claim 1, wherein the triggering event includes the subject person passing away.

3. The method of claim 1, wherein the predetermined selection criteria include whether a media content item includes content that meets one or more importance criteria.

4. The method of claim 1, wherein the predetermined selection criteria include whether a media content item includes content that meets one or more quality criteria.

5. The method of claim 1, wherein the predetermined selection criteria include whether a set of media content items includes content that meets one or more diversity criteria.

6. A method comprising:
determining a triggering event associated with a subject person;
receiving a plurality of media content items associated with the subject person;
selecting media content items from the plurality of media content items based on one or more predetermined selection criteria; and
providing a summary presentation of the selected content media items.

7. The method of claim 6, wherein the triggering event includes the subject person passing away.

8. The method of claim 6, wherein the receiving comprises searching for the media content items in response to detecting the triggering event.

9. The method of claim 6, wherein the plurality of media content items include one or more of videos, images, and audio recordings.

10. The method of claim 6, wherein the predetermined selection criteria include whether a media content item includes the subject person.

11. The method of claim 6, wherein the predetermined selection criteria include whether a media content item includes content that meets one or more social affinity criteria.

12. The method of claim 6, wherein the predetermined selection criteria include whether a media content item includes content that meets one or more importance criteria.

13. The method of claim 6, wherein the predetermined selection criteria include whether a media content item includes content that meets one or more quality criteria.

14. The method of claim 6, wherein the predetermined selection criteria include whether a set of media content items includes content that meets one or more diversity criteria.

15. The method of claim 6, wherein the selecting of the media content items comprises:
ranking based on a predetermined selection criteria; and
selecting a predetermined number of media content items based on the ranking.

16. The method of claim 6, wherein the providing of the summary presentation comprises selecting one or more recipients based on one or more recipient criteria.

17. A system comprising:
one or more processors; and
logic encoded in one or more tangible media for execution by the one or more processors and when executed operable to perform operations comprising: determining a triggering event associated with a subject person;
receiving a plurality of media content items associated with the subject person;
selecting media content items from the plurality of media content items based on one or more predetermined selection criteria; and
providing a summary presentation of the selected content media items.

18. The system of claim 17, wherein the triggering event includes the subject person passing away.

19. The system of claim 17, wherein the receiving comprises searching for the media content items in response to detecting the triggering event.

20. The system of claim 17, wherein the plurality of media content items include one or more of videos, images, and audio recordings.
